(19) United States
(12) Patent Application Publication
(10) Pub. No.: US 2021/0379702 A1
(43) Pub. Date: Dec. 9, 2021

(54) ETCHING APPARATUS

(71) Applicant: NPS CO., LTD., Cheongju-si (KR)

(72) Inventor: Seong Ho BAE, Daejeon (KR)

(21) Appl. No.: 17/339,252

(22) Filed: Jun. 4, 2021

(30) Foreign Application Priority Data
Jun. 5, 2020 (KR) 10-2020-0068532
Jun. 12, 2020 (KR) 10-2020-0071226

(51) Int. Cl. B23K 26/38; B23K 26/14; B23K 26/073

(52) U.S. Cl. CPC B23K 26/38; B23K 26/073; B23K 26/1462

(57) ABSTRACT

An etching apparatus includes an etching unit including a laser oscillator configured to oscillate a laser beam for selectively etching a predetermined target etch layer included in a processing target having a multilayered structure, and a laser nozzle configured to selectively etch the target etch layer by irradiating the target etch layer with the laser beam, and a washing unit including a washing nozzle configured to remove a foreign substance attached to an etch surface of the target etch layer by spraying a washing material to the etch surface.

### CROSS-REFERENCE TO RELATED APPLICATION

This application claims priority from Korean Patent Application No. 10-2020-0068532, filed on Jun. 5, 2020, and Korean Patent Application No. 10-2020-0071226, filed on Jun. 12, 2020, in the Korean Intellectual Property Office, and all the benefits accruing therefrom under 35 U.S.C. 119, the contents of which in its entirety is herein incorporated by reference.

### BACKGROUND

### 1. Technical Field

The present disclosure relates to an etching apparatus.

### 2. Description of the Related Art

Recently, as the demand for portable electronic products such as laptops, video cameras, and portable telephones has rapidly increased, and electric vehicles, energy storage batteries, robots, satellites, etc. have been actively developed, research has been conducted into high-performance secondary batteries capable of being repeatedly charged and discharged.

Such a secondary battery includes an electrode assembly in which a plurality of electrodes and a plurality of separators are alternately disposed, and an exterior material for sealing and accommodating the electrode assembly together with an electrolyte, that is, a battery case. The electrode includes an electrode current collector and an electrode active material layer formed on one surface of the electrode current collector by coating an electrode active material thereon.

In general, an electrode active material layer may be formed using a coating process of forming the electrode active material layer by coating an electrode active material slurry on one surface of an electrode current collector using a slot die coater, and a rolling process for rolling an electrode including the electrode active material layer formed thereon. In particular, the rolling process is performed using a heating plate for supporting the electrode, a rolling roller for adhering the electrode active material layer to the electrode current collector by pressing the electrode in the state in which the electrode is supported by the heating plate, and the like.

A part of an entire region of the electrode current collector, on which the electrode active material is not coated and which is exposed to the outside, is referred to as an uncoated part. Through a notching process of shearing the uncoated part, an electrode tab for electrically connecting a secondary battery to an external power source and other members may be formed on the uncoated part.

However, in general, the coating process and the rolling process are performed in a roll-to-roll manner of coating and rolling an electrode active material with respect to electrode current collector fabric that is unwound and supplied from a supply roll and is then wound and recovered by a recovery roll. When the coating process and the rolling process are performed in the roll-to-roll manner, a surface of the electrode active material layer may be uneven due to curling of the electrode current collector fabric, vibration applied from the outside, and other causes. As such, when the surface of the electrode active material layer is uneven, error occurs in the distance to boundary of the electrode active material layer, that is, to a shoulder line of the uncoated part from an end of the electrode current collector. Accordingly, a conventional electrode has a problem in that the shoulder line of the uncoated part is not uniformly formed and thus an electrode and a product manufactured using the same become defective.

### SUMMARY

Therefore, the present disclosure has been made in view of the above problems, and it is an object of the present disclosure to provide an etching apparatus improved to selectively etch a target etch layer of a processing target using a laser beam.

In addition, the present disclosure relates to an etching apparatus improved to remove a foreign substance formed during a procedure of etching a target etch layer from a processing target.

In accordance with the present disclosure, the above and other objects can be accomplished by the provision of an etching apparatus including an etching unit including a laser oscillator configured to oscillate a laser beam for selectively etching a predetermined target etch layer included in a processing target having a multilayered structure, and a laser nozzle configured to selectively etch the target etch layer by irradiating the target etch layer with the laser beam, and a washing unit including a washing nozzle configured to remove a foreign substance attached to an etch surface of the target etch layer by spraying a washing material to the etch surface of the target etch layer.

The laser nozzle may emit the laser beam along an etching scheduled line to form the etch surface along the etching scheduled line.

The etching scheduled line may be set to etch one end surface of the target etch layer along the etching scheduled line.

The washing nozzle may be configured in such a way that a washing particle in a solid state, which is a sublimable material, of the washing material collides with the etch surface.

The washing material may be carbon dioxide (CO2), and the washing particle in a solid state may be a dry ice fine particle.

The washing nozzle may be installed to be spaced apart from the etch surface by a predetermined distance to phase-transition a washing material in a liquid state sprayed toward the etch surface into the washing particle in a solid state during a procedure in which the washing material in a liquid state reaches the etch surface.

The processing target may further include a base material layer stacked on one surface of the target etch layer, and the laser oscillator may generate and oscillate a laser beam for which a laser absorption rate of the target etch layer is higher than a laser absorption rate of the base material layer.

When the base material layer is formed of a metal material and the target etch layer is formed of a carbon-based material, the laser oscillator may generate and oscillate an infrared laser beam.

The etching unit may further include a beam shaping member configured to shape a circular laser beam oscillated from the laser oscillator into an elliptical laser beam, and the laser nozzle may irradiate the target etch layer with the elliptical laser beam along a long-axis direction of the elliptical laser beam.

The etching apparatus may further include a supply unit configured to supply the processing target in the long-axis direction along a predetermined supply path, wherein the laser nozzle may be installed to irradiate the target etch layer passing through a predetermined etching section on the supply path with the laser beam.

The washing nozzle may be installed to spray the washing material toward the etch surface of the processing target passing through a predetermined washing section positioned on a downstream side of the supply path compared with the etching section.

The laser nozzle may irradiate the target etch layer with the elliptical laser beam in such a way that beam spots of the elliptical laser beam overlap each other by a predetermined overlap ratio in the long-axis direction.

The beam shaping member may include a plurality of cylindrical lenses installed at a predetermined interval on an optical path of the circular laser beam, and the cylindrical lenses are installed in such a way that a center line of a circumferential surface included in a corresponding cylindrical lens is parallel to the long-axis direction.

The cylindrical lenses may be installed to align a center axis of the corresponding cylindrical lens and an optical axis of the circular laser beam.

The washing unit may further include a suction unit configured to absorb and remove the foreign substance separated from the etch surface by the washing particle.

The washing unit may further include an ionizer configured to neutralize the etch surface by emitting ions toward the etch surface.

### BRIEF DESCRIPTION OF THE DRAWINGS

The above and other features of the inventive concept will become more apparent by describing in detail exemplary embodiments thereof with reference to the accompanying drawings, in which:

FIG. 1 is a side view for explaining a multilayered structure of a processing target;

FIG. 2 is a plan view for explaining the multilayered structure of the processing target;

FIG. 3 is a side view showing a schematic configuration of an etching apparatus according to an embodiment of the present disclosure;

FIG. 4 is a diagram showing a schematic configuration of an optical member included in an etching unit;

FIGS. 5 and 6 are diagrams showing a pattern in which a circular laser beam is shaped into an elliptical laser beam by an optical member;

FIG. 7 is a diagram showing the state in which a circular laser beam is shaped into an elliptical laser beam by an optical member;

FIG. 8 is a diagram for explaining a method of setting an etching scheduled line on a target etch layer;

FIG. 9 is a diagram showing a pattern in which a target etch layer is etched using an elliptical laser beam;

FIG. 10 is a side view of a processing target, which shows the state in which a target etch layer is etched;

FIG. 11 is a plan view of a processing target, which shows the state in which a target etch layer is etched;

FIG. 12 is a diagram showing a pattern in which a target etch layer is etched using a circular laser beam;

FIG. 13 is a side view of an etching apparatus showing the state in which a processing target reaches a predetermined washing section;

FIG. 14 is a front view showing a schematic configuration of a washing unit according to an embodiment;

FIG. 15 is a side view showing a schematic configuration of a washing unit according to another embodiment;

FIG. 16 is a side view showing a schematic configuration of an electrode manufacturing system including an etching apparatus installed therein according to another embodiment of the present disclosure; and

FIG. 17 is a side view showing a schematic configuration of the etching apparatus shown in FIG. 16.

### DETAILED DESCRIPTION

Hereinafter, some embodiments of the present disclosure will be described in detail with reference to the accompanying drawings. In the following description, like reference numerals designate like elements although the elements are shown in different drawings. Further, in the following description of the embodiments of the present disclosure, a detailed description of known functions and configurations incorporated herein will be omitted for clarity and brevity.

It will be understood that, although the terms first, second, A, B, (a), (b), etc. may be used herein to describe various elements of the present disclosure, these terms are only used to distinguish one element from another element and essential feature, order, or sequence of corresponding elements are not limited by these terms. Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

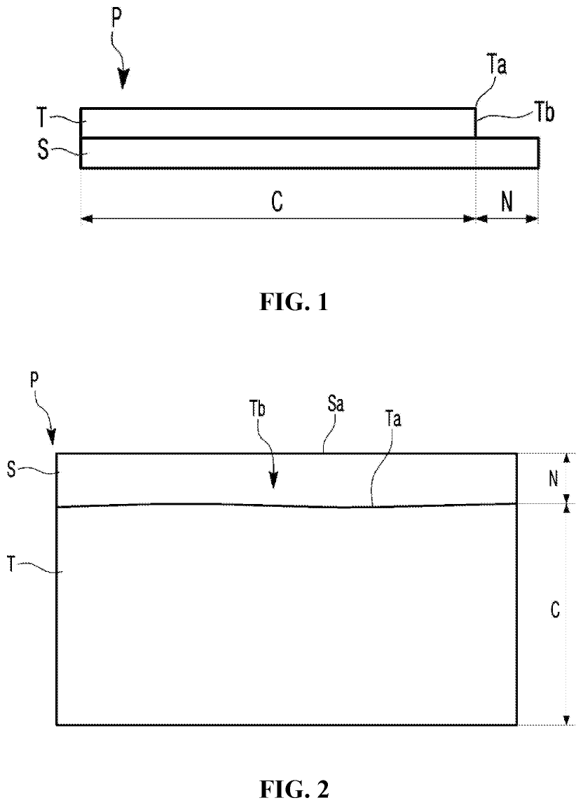

FIG. 1 is a side view for explaining a multilayered structure of a processing target. FIG. 2 is a plan view for explaining the multilayered structure of the processing target.

An etching apparatus 1 according to an embodiment of the present disclosure may be an apparatus for selectively etching and processing a predetermined target etch layer T of a processing target P having a multilayered structure.

The type of the processing target P is not particularly limited. For example, the processing target P may be a unit electrode sheet to be used as an electrode of a secondary battery.

The multilayered structure of the processing target P is not particularly limited. For example, the processing target P may have a multilayered structure including a base material layer S and the target etch layer T stacked on one surface of the base material layer S. In particular, when the processing target P is a unit electrode sheet, the base material layer S may correspond to the electrode current collector and may be formed of a metal material, and the target etch layer T may correspond to an electrode active material coated on one surface of the electrode current collector and may be formed of a carbon-based material.

When the processing target P is a unit electrode sheet, the target etch layer T may be selectively coated only on a part of an entire region of the base material layer S. For example, as shown in FIGS. 1 and 2, the target etch layer T may be selectively coated on a region of the base material layer S to expose one end Sa of the base material layer S to the outside. Hereinafter, a part of an entire region of the base material layer S, on which the target etch layer T is coated, will be referred to as a coating part C, a part of the entire region of the base material layer S, on which the target etch layer T is not coated and which is exposed to the outside, will be referred to as an uncoated part N.

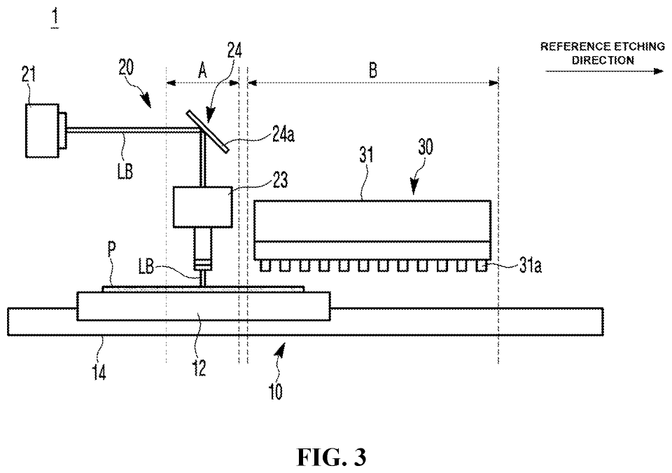

FIG. 3 is a side view showing a schematic configuration of an etching apparatus according to an embodiment of the present disclosure.

The etching apparatus 1 may be provided to selectively etch the target etch layer T using a laser scribing process of shaving the target etch layer T by irradiating the target etch layer T with a laser beam LB. For example, as shown in FIG. 3, the etching apparatus 1 may include a supply unit 10 for supplying the processing target P along a predetermined supply path, an etching unit 20 for selectively etching the target etch layer T by irradiating the target etch layer T with the laser beam LB to scribe the target etch layer T, and a washing unit 30 for removing a foreign substance R attached to the etch surface S of the target etch layer T by spraying a washing material to an etch surface S of the target etch layer T.

First, the supply unit 10 may be a device for supplying the processing target P along a predetermined supply path.

As shown in FIG. 3, the supply unit 10 may include a support block 12 on which the processing target P is accommodated, a guide rail 14 on which the support block 12 is moveably installed along the supply path, and a driving member (not shown) for moving the support block 12 along the supply path under guidance of the guide rail 14. The supply path of the processing target P is not particularly limited and may be determined to move the support block 12 by a predetermined distance in a predetermined reference etching direction.

The supply unit 10 may supply the processing target P accommodated on the support block 12 in the reference etching direction on the supply path.

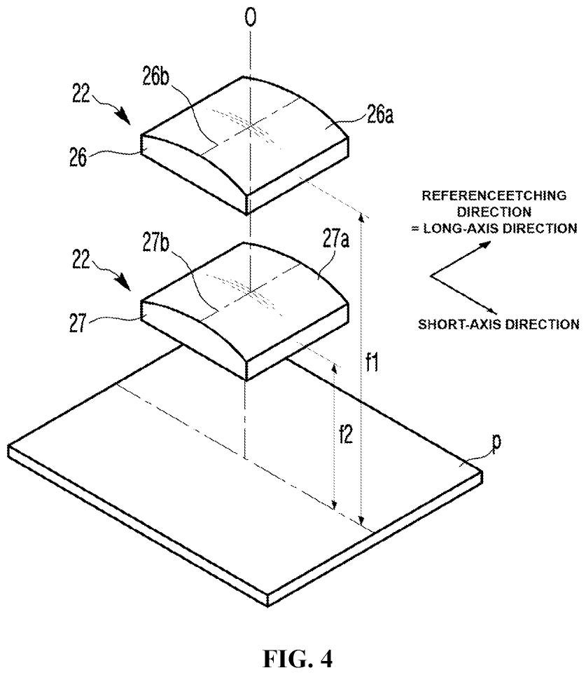

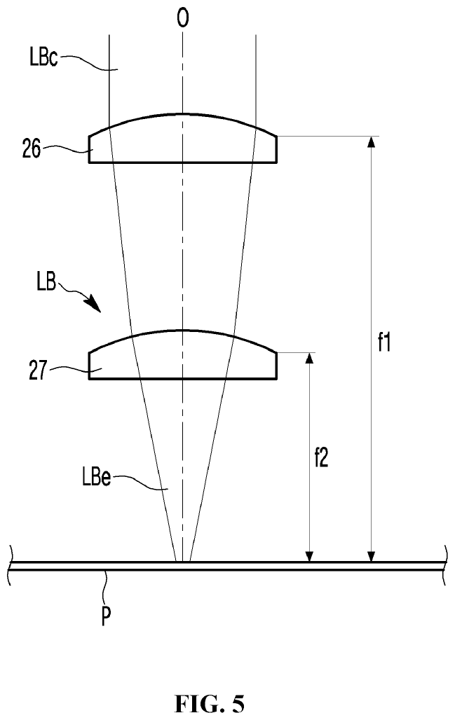

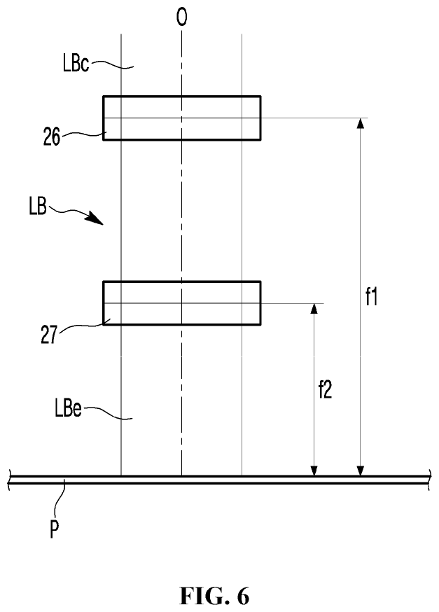

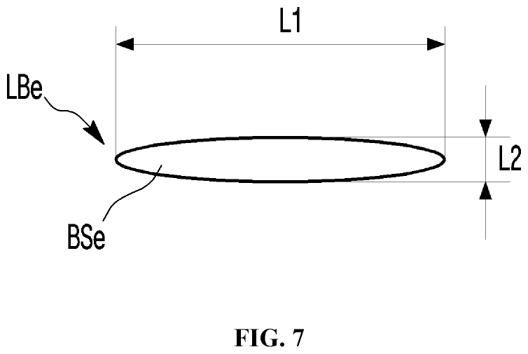

FIG. 4 is a diagram showing a schematic configuration of an optical member included in an etching unit. FIGS. 5 and 6 are diagrams showing a pattern in which a circular laser beam is shaped into an elliptical laser beam by an optical member. FIG. 7 is a diagram showing the state in which a circular laser beam is shaped into an elliptical laser beam by an optical member.

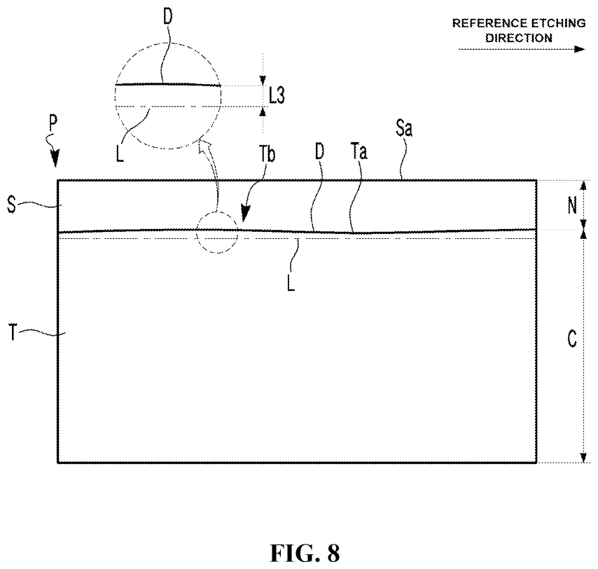

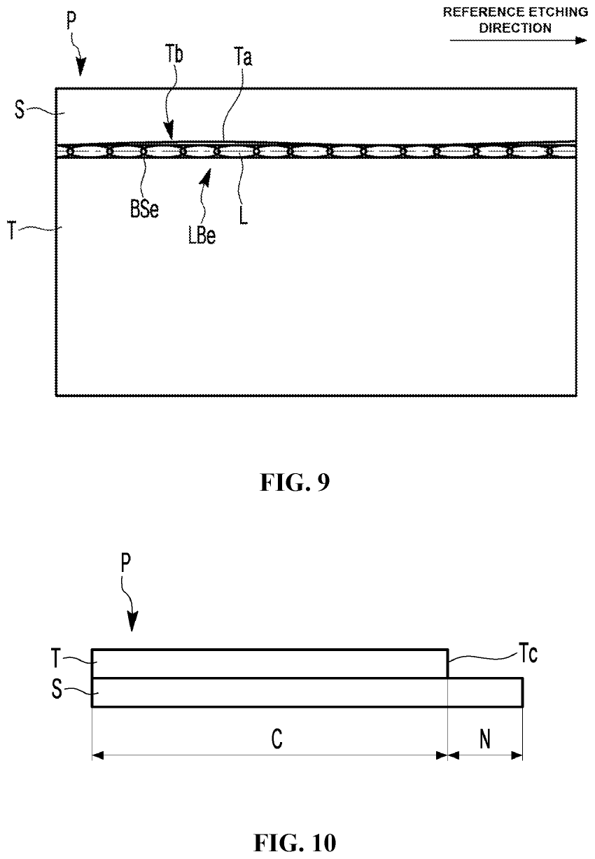

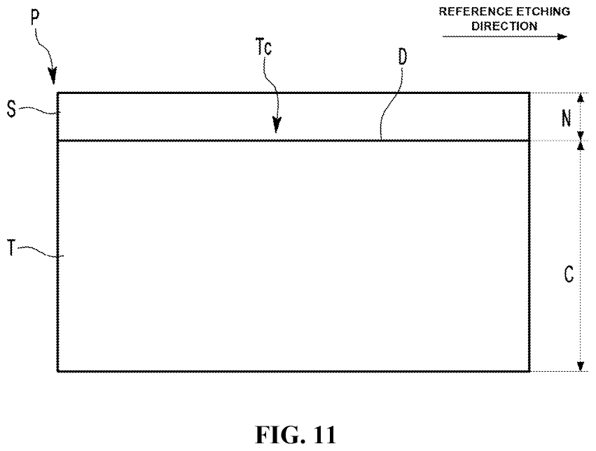

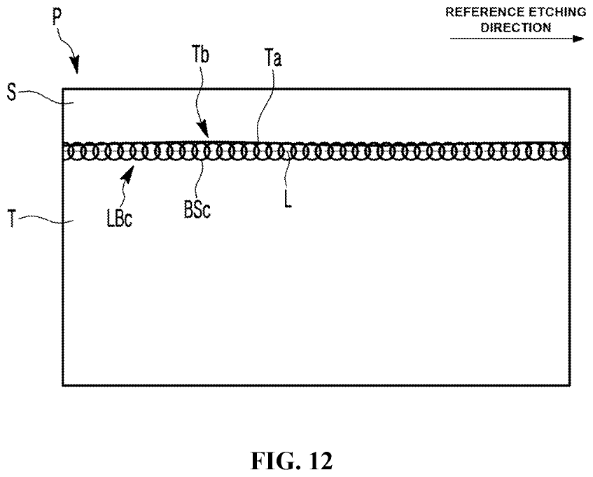

FIG. 8 is a diagram for explaining a method of setting an etching scheduled line on a target etch layer. FIG. 9 is a diagram showing a pattern in which a target etch layer is etched using an elliptical laser beam. FIG. 10 is a side view of a processing target, which shows the state in which a target etch layer is etched. FIG. 11 is a plan view of a processing target, which shows the state in which a target etch layer is etched. FIG. 12 is a diagram showing a pattern in which a target etch layer is etched using a circular laser beam.

Next, the etching unit 20 is a device for selectively etching the target etch layer T by scribing the target etch layer T.

As shown in FIGS. 3 and 4, the etching unit 20 may include a laser oscillator 21 for generating and oscillating the laser beam LB, a beam shaping member 22 for shaping the laser beam LB oscillated from the laser oscillator 21 to have a sectional shape of an ellipse, and a laser nozzle 23 for selectively etching the target etch layer T by irradiating the target etch layer T with the laser beam LB, which is shaped to have a sectional shape of an ellipse by the beam shaping member 22, to scribe the target etch layer T.

The laser oscillator 21 may be provided to generate and oscillate the laser beam LB for selectively etching the target etch layer T.

In general, a laser absorption rate for a laser beam of a specific source and wavelength may be different for each material. Here, the laser absorption rate may refer to a ratio of energy absorbed by a material among total energy of a laser beam. Thus, as a laser absorption rate of a material with respect to a specific type of laser beam is increased, the material may be more smoothly processed by the corresponding laser beam.

According to the characteristics of the laser beam, in order to selectively etch the target etch layer T using the laser beam LB, the laser oscillator 21 may generate and oscillate the laser beam LB having a predetermined wavelength and source, for which a laser absorption rate of the target etch layer T is higher than a laser absorption rate of the base material layer S. For example, when the base material layer S is formed of a metal material and the target etch layer T is formed of a carbon-based material, the laser oscillator 21 may generate and oscillate an infrared laser beam for which a laser absorption rate of a carbon-based material is higher than a laser absorption rate of a metal material.

The beam shaping member 22 may shape the laser beam LB oscillated from the laser oscillator 21 to have a sectional shape of an ellipse.

In general, a laser beam may be generated to have a sectional shape of a circle, and thus the laser beam LB generated and oscillated by the laser oscillator 21 may also have a sectional shape of a circle. Thus, the beam shaping member 22 may be configured to shape the laser beam LB having a sectional shape of a circle, transmitted from the laser oscillator 21, to have a sectional shape of an ellipse. Here, the sectional shape of the laser beam LB may refer to a shape of a beam spot of the laser beam LB irradiated at a processing point. For convenience of description, hereinafter, the laser beam LB having a sectional shape of a circle, oscillated from the laser oscillator 21, will be referred to as a circular laser beam LBc, and the laser beam LB that is shaped to have a sectional shape of an ellipse by the beam shaping member 22 will be referred to as an elliptical laser beam LBe.

The structure of the beam shaping member 22 is not particularly limited. For example, as shown in FIG. 4, the beam shaping members 22 may be sequentially installed on an optical path of the circular laser beam LBc at a predetermined interval and may include a plurality of cylindrical lenses 26 and 27 that sequentially shape the circular laser beam LBc into the elliptical laser beam LBe. For convenience of description, hereinafter, a method of shaping the circular laser beam LBc into the elliptical laser beam LBe will be described with regard to an example in which one pair of cylindrical lenses 26 and 27 including a first cylindrical lens 26 and a second cylindrical lens 27 is installed on an optical path of the circular laser beam LBc.

A cylindrical lens refers to a lens, front and rear surfaces of which are circumferential surfaces having parallel generators. The cylindrical lens does not cause refraction on a plane including the generator, but causes refraction in a plane perpendicular to the generator, and accordingly, an image of a laser beam passing through the cylindrical lens may be a straight line parallel to the generator. Similarly to a result formed by cutting a portion of a cylinder in a longitudinal direction, a top surface of the cylindrical lens may correspond to a convex circumferential surface and a bottom surface of the cylindrical lens may correspond to a flat surface. Thus, the laser beam passing through the cylindrical lens may be symmetrically focused in a predetermined ratio based on a center line of the circumferential surface that is parallel to the bottom surface of the cylindrical lens and allows an optical axis of the laser beam to vertically pass through the center of the circumferential surface, and thus may have an elliptical shape, a long axis of which is parallel to the center line of the circumferential surface.

Based on the aforementioned characteristics of the cylindrical lens, the first cylindrical lens 26 and the second cylindrical lens 27 may be installed to shape the circular laser beam LBc into the elliptical laser beam LBe.

For example, as shown in FIG. 4, the first cylindrical lens 26 may have a predetermined first focal distance f1 and may be installed to be spaced apart from the target etch layer T by the first focal distance f1. In particular, the first cylindrical lens 26 may be installed on an optical path of the laser beam LB to align an optical axis O of the laser beam LB and a center axis of the first cylindrical lens 26 and to position an extension direction of a center line 26b of a circumferential surface 26a in parallel to a reference etching direction.

The second cylindrical lens 27 may be installed between the processing target P and the first cylindrical lens 26 to have a second focal distance f2 shorter than the first focal distance f1 of the first cylindrical lens 26 and to be spaced apart from the processing target P by the second focal distance f2. In particular, the second cylindrical lens 27 may be installed on the optical path of the laser beam LB to align the optical axis O of the laser beam LB and the center axis of the second cylindrical lens 27 and to position an extension direction of a center line 27b of a circumferential surface 27a in parallel to the reference etching direction.

As described above, as the first cylindrical lens 26 and the second cylindrical lens 27 are installed, the circular laser beam LBc may be symmetrically focused in a perpendicular direction to the center line 26b of the circumferential surface 26a, that is, in a short-axis direction of the elliptical laser beam LBe based on the center line 26b of the circumferential surface 26a while passing through the first cylindrical lens 26, and thus may be primarily shaped into an ellipse, as shown in FIG. 5. Then, as shown in FIG. 5, while passing through the second cylindrical lens 27, the circular laser beam LBc that is primarily shaped into an ellipse may be symmetrically focused in a perpendicular direction to the center line 27b of the circumferential surface 27a, that is, in a short-axis direction of the elliptical laser beam LBe based on the center line 27b of the circumferential surface 27a, and thus may be secondarily shaped into an ellipse.

As shown in FIG. 6, while passing through the first cylindrical lens 26 and the second cylindrical lens 27, the circular laser beam LBc may not be focused in a parallel direction to the center lines 26b and 27b of the corresponding cylindrical lenses 26 and 27, that is, in a long-axis direction of the elliptical laser beam LBe. Accordingly, as shown in FIG. 7, the circular laser beam LBc that sequentially passes through the first cylindrical lens 26 and the second cylindrical lens 27 may be shaped into the elliptical laser beam LBe having a long elliptical shape in which a long-axis diameter L1 is longer than a short-axis diameter L2 by a predetermined ratio.

As described above, the beam shaping member 22 may shape the circular laser beam LBc into the elliptical laser beam LBe using the plurality of cylindrical lenses 26 and 27 over multiple times. As such, the beam shaping member 22 may generate the elliptical laser beam LBe having a high ratio of the long-axis diameter L1 to the short-axis diameter L2 compared with the case in which a circular laser beam is shaped into an elliptical laser beam selectively using only one cylindrical lens.

An installation position of the beam shaping member 22 is not particularly limited. For example, the beam shaping member 22 may be installed inside the laser nozzle 23 to allow the circular laser beam LBc transmitted to the laser nozzle 23 to be incident.

The laser nozzle 23 may be provided to irradiate the target etch layer T of the processing target P with the laser beam LB oscillated from the laser oscillator 21. To this end, as shown in FIG. 3, at least one optical member 24 for transmitting the circular laser beam LBc oscillated from the laser oscillator 21 in a predetermined state, such as a reflection mirror 24a for converting an optical path of the circular laser beam LBc oscillated from the laser oscillator 21, a collimator (not shown) for shaping the circular laser beam LBc oscillated from the laser oscillator 21 into parallel light, or a beam expander (not shown) for enlarging a diameter of the circular laser beam LBc may be installed between the laser oscillator 21 and the laser nozzle 23. Accordingly, after being transmitted in a predetermined state to the laser nozzle 23 by the optical members 24, the circular laser beam LBc may be shaped into the elliptical laser beam LBe by the beam shaping member 22 installed inside the laser nozzle 23.

The laser nozzle 23 may be installed to irradiate the target etch layer T with the elliptical laser beam LBe along a predetermined etching scheduled line L. Here, the etching scheduled line L may be an imaginary line for emitting the elliptical laser beam LBe and may be set to extend in a predetermined reference etching direction.

In a general process of manufacturing an electrode for a secondary battery, a coating process of coating an electrode active material on an electrode current collector and a rolling process of pressing the electrode active material coated on the electrode current collector to adhere the electrode active material to the electrode current collector may be performed in a roll-to-roll manner of coating and rolling the electrode active material with respect to electrode current collector fabric that is unwound and supplied from a supply roll and is then wound and recovered by a recovery roll. When the roll-to-roll manner is used, a shoulder line D of an uncoated part N formed by one end Ta of the target etch layer T may have an irregular non-linear shape due to curling of the electrode current collector fabric, vibration applied from the outside, and other causes, as shown in FIG. 8. Here, the shoulder line D of the uncoated part N may correspond to a boundary line for defining a boundary between the uncoated part N and the coating part C.

When the shoulder line D of the uncoated part N has an irregular non-linear shape, abnormalities may occur in the quality of a unit electrode sheet and a product manufactured using the same. Thus, as shown in FIG. 8, when the processing target P is a unit electrode sheet, the etching scheduled line L may be set to be spaced apart from the end Ta of the target etch layer T at a predetermined clearance L3 in the reference etching direction to etch and process the end Ta of the target etch layer T for forming the shoulder line D of the uncoated part N in a straight line. In this case, the processing target P may be accommodated in a predetermined position of the support block 12 to position a long-axis direction of the elliptical laser beam LBe in parallel to the reference etching direction.

A method of irradiating the target etch layer T with the elliptical laser beam LBe along the etching scheduled line L using the laser nozzle 23 is not particularly limited. For example, as shown in FIG. 3, in the state in which the laser nozzle 23 is previously positioned in a predetermined etching section A, the laser oscillator 21 may be driven to irradiate the etching scheduled line L of the processing target P, passing through the predetermined etching section A, with the elliptical laser beam LBe emitted from the laser nozzle 23. To this end, the etching unit 20 may further include a laser nozzle mover (not shown) for moving the laser nozzle 23 in at least one direction of length and width directions of the processing target P.

As such, when the laser oscillator 21 is driven in the state in which the laser nozzle 23 is previously positioned in the etching section A, the target etch layer T may be etched along the etching scheduled line L by irradiating the target etch layer T with the elliptical laser beam LBe emitted from the laser nozzle 23 along the etching scheduled line L, as shown in FIG. 9. However, the present disclosure is not limited thereto, and the laser nozzle 23 may also irradiate the target etch layer T with the elliptical laser beam LBe along the etching scheduled line L while being moved by a laser nozzle mover (not shown) in the reference etching direction.

As shown in FIG. 9, the elliptical laser beam LBe may be emitted to the target etch layer T to position the beam spots BSe to overlap each other by a predetermined overlap ratio in a long-axis direction of the elliptical laser beam LBe, that is, in the reference etching direction. Here, the overlap ratio of the beam spots BSe may be adjusted by changing an oscillation period of the laser beam LB, a feed rate of the processing target P, or the like.

When the elliptical laser beam LBe is emitted to the target etch layer T to position the beam spots BSe to overlap each other in the reference etching direction, a specific region of the target etch layer T, corresponding to the etching scheduled line L, may be etched and removed by energy transmitted from the elliptical laser beam LBe, as shown in FIGS. 10 and 11. Thus, an etching surface Tc may be formed in a boundary of a specific region of the target etch layer T in parallel to the etching scheduled line L, and the specific region of the base material layer S, which is covered by a specific region of the target etch layer T, may be exposed to the outside.

For example, when the etching scheduled line L is formed to be spaced apart from the end Ta of the target etch layer T for forming the shoulder line D of the uncoated part N at the predetermined clearance L3, one end surface Tb of the target etch layer T may be etched and removed, and the etching surface Tc formed by etching the end surface Tb of the target etch layer T may function as a new one end surface of the target etch layer T. However, the etching scheduled line L may have a shape of a straight line extending in the reference etching direction, and thus the etching surface Tc of the target etch layer T may be constantly formed to have a shape of a straight line extending in the reference etching direction. Then, the shoulder line D of the uncoated part N may also be constantly formed to have a shape of a straight line, and as such, the etching apparatus 1 may improve the quality of the processing target P and a product manufactured using the same.

As shown in FIGS. 9 and 12, when the target etch layer T is etched using the elliptical laser beam LBe extending a long way in the reference etching direction, the number of beam spots BSe and BSc, that is, laser pulses required to etch the target etch layer T may be reduced compared with the case in which the target etch layer T is etched using a circular laser beam LBo.

Thus, when the target etch layer T is etched using the elliptical laser beam LBe, the time and energy taken to etch the target etch layer T may be reduced. In the elliptical laser beam LBe, energy may be intensively distributed around a long axis thereof differently from the circular laser beam LBc in which energy is evenly distributed without directionality. Thus, when the target etch layer T is etched using the elliptical laser beam LBe, energy of the laser beam LB may be intensively distributed around an etching region of the target etch layer T compared with the case in which the target etch layer T is etched using the circular laser beam LBc, and thus a surrounding part adjacent to the etching region of the target etch layer T may be prevented from being etched, and the target etch layer T may be smoothly etched to make the etching surface Tc smooth and gentle.

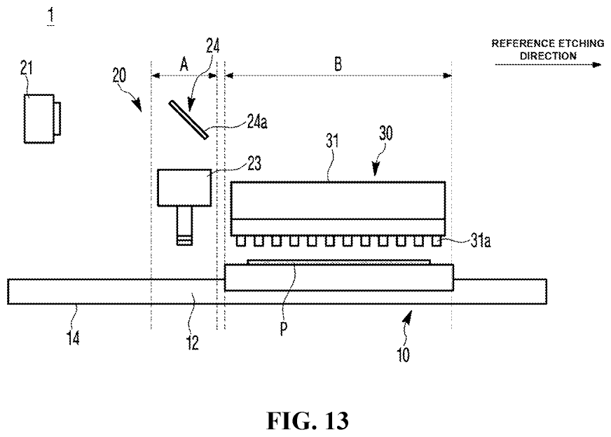

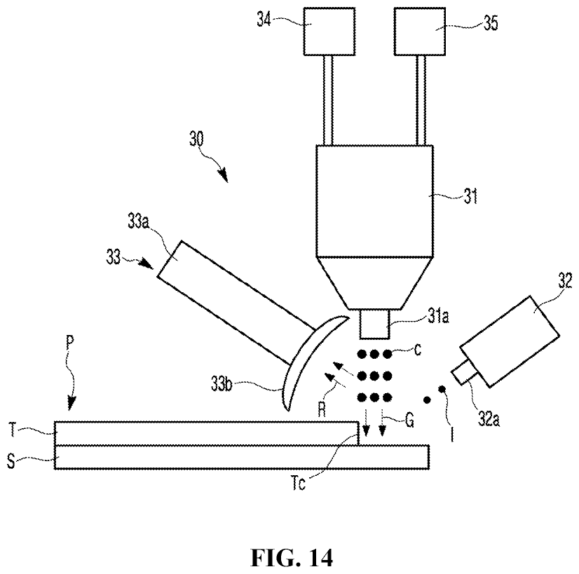

FIG. 13 is a side view of an etching apparatus showing the state in which a processing target reaches a predetermined washing section. FIG. 14 is a front view showing a schematic configuration of a washing unit according to an embodiment.

Next, the washing unit 30 is a device for removing the foreign substance R attached to the etching surface Tc of the target etch layer T.

When the target etch layer T is etched using the laser beam LB, particles of a carbon-based material included in the target etch layer T and other foreign substances R formed when the target etch layer T is etched may be attached to the etching surface Tc of the target etch layer T, an exposed surface of the base material layer S, exposed to the outside by etching the target etch layer T, etc. (hereinafter referred to as “the etching surface Tc of the target etch layer T, etc.”). Due to the foreign substance R, abnormalities may occur in the quality of the processing target P and a product manufactured using the same.

To overcome this, as shown in FIGS. 13 and 14, the washing unit 30 may include a washing material source 34 for supplying a washing material, a carrier gas source 35 for supplying carrier gas G, and a washing nozzle 31 for spraying a resultant formed by mixing the washing material supplied from the washing material source 34 and the carrier gas G supplied from the carrier gas source 35 to the etching surface Tc of the target etch layer T, etc.

A material used as the washing material is not particularly limited, and any material sublimable at room temperature may be used as the washing material. For example, the washing material may be carbon dioxide (CO2). In this case, the washing material source 34 may supply a washing material in a liquid state to the washing nozzle 31 but the present disclosure is not limited thereto.

The type of gas to be used as the carrier gas G is not particularly limited. For example, the carrier gas G may be high-purity air or nitrogen dioxide (NO2). The carrier gas source 35 may press the carrier gas G at a predetermined reference pressure (e.g., 6 bar) or more and may supply the carrier gas G to the washing nozzle 31.

The washing nozzle 31 may be provided to spray a resultant formed by mixing the washing material in a liquid state supplied from the washing material source 34 and the carrier gas G supplied from the carrier gas source 35 to the etching surface Tc of the target etch layer T, etc. To this end, as shown in FIGS. 13 and 14, the washing nozzle 31 may include a plurality of discharge ports 31a for discharging the resultant formed by mixing the washing material in a liquid state and the carrier gas G to the etching surface Tc of the target etch layer T, etc. The discharge ports 31a may be installed at a predetermined interval in the reference etching direction but the present disclosure is not limited thereto.

In general, a sublimable material such as CO2 may have properties of sublimating to a gas phase after phase transition to a solid phase when exposed to the atmosphere for a predetermined time or more in a liquid state. Accordingly, the washing nozzle 31 may be installed to spray a washing material at a position spaced apart from the etching surface Tc of the target etch layer T, etc. by a predetermined distance to cause phase transition into a washing particle C in a solid phase during a procedure in which the washing material in a liquid phase sprayed from the washing nozzle 31 reaches the etching surface Tc of the target etch layer T, etc.

For example, when the washing material is CO2, the washing nozzle 31 may be installed to be spaced apart from the etching surface Tc of the target etch layer T, etc. by a predetermined distance to cause phase transition into dry ice fine particles (snow & pellet) during a procedure in which CO2 in a liquid state sprayed from the washing nozzle 31 reaches the etching surface Tc of the target etch layer T, etc.

The washing unit 30 may further include a washing nozzle mover (not shown) for reciprocating the washing nozzle 31 to approach the etching surface Tc of the target etch layer T, etc. or to be spaced apart from the etching surface Tc of the target etch layer T, etc.

An installation location of the washing nozzle 31 and a washing time of the etching surface Tc of the target etch layer T using the washing nozzle 31 are not particularly limited. For example, as shown in FIG. 13, the washing nozzle 31 may be installed in the washing section B to direct the discharge ports 31a toward the etching surface Tc of the target etch layer T of the processing target P passing through the predetermined washing section B on the supply path. Here, the washing section B may be set to be spaced apart from the etching section A by a predetermined distance in the reference etching direction and to be positioned on a downstream side of the supply path compared with the etching section A. Then, as shown in FIG. 14, the washing nozzle 31 may spray a washing material and the carrier gas G toward the etching surface Tc of the target etch layer T, etc., which enter the washing section B by the supply unit 10.

Hereinafter, a pattern in which the etching surface Tc of the target etch layer T, etc. are washed by the washing particle C will be described with regard to an example in which a washing material is CO2 and the washing particle C in a solid state is a dry ice fine particle.

Dry ice fine particles that reach the etching surface Tc of the target etch layer T, etc. under guidance of the carrier gas G at high speed and high pressure may collide with the foreign substance R attached to the etching surface Tc of the target etch layer T, etc. to apply physical impact force to the foreign substance R. Thus, the foreign substance R attached to the etching surface Tc of the target etch layer T, etc. may be separated from the etching surface Tc of the target etch layer T, etc. Along therewith, when dry ice fine particles and the foreign substance R collide with each other, cracks may occur in the foreign substance R as the foreign substance R cools and contracts due to thermal shock caused by low-temperature air current, and the foreign substance R may be separated from the etching surface Tc of the target etch layer T, etc. as the dry ice fine particles sublimate and the volume thereof significantly expands. In addition, an organic material included in the foreign substance R may be removed by being dissolved in dry ice, and moisture included in the foreign substance R may be frozen by dry ice and transition into a solid state, and then sublimated and removed.

Through this procedure, dry ice fine particles may wash the etching surface Tc of the target etch layer T, etc. by removing particles of carbon-based materials and other foreign substances R attached to the etching surface Tc of the target etch layer T, etc.

However, when the size of dry ice fine particles colliding with the etching surface Tc of the target etch layer T, etc. becomes larger than an appropriate level, there is concern over a problem in that moisture in the foreign substance R attached to the etching surface Tc of the target etch layer T, etc. dose not rapidly sublimate due to energy transferred from the dry ice fine particles and remains in a liquid state for a predetermined time or more. Thus, the washing nozzle 31 may be provided to make the dry ice fine particles have a diameter equal to or less than a predetermined reference size.

When the etching surface Tc of the target etch layer T, etc. are washed, residual particles of the foreign substance R separated from the etching surface Tc of the target etch layer T, etc. may be attached to the etching surface Tc of the target etch layer T, etc. again. In particular, when the etching surface Tc of the target etch layer T, etc. are charged by the washing particle C, the residual particles of the foreign substance R may be more frequently attached to the etching surface Tc of the target etch layer T, etc. again. As such, the residual particles of the foreign substance R that is attached to the etching surface Tc of the target etch layer T, etc. again may reduce efficiency of removing the foreign substance R using the washing particle C and may degrade the quality of the processing target P and a product manufactured using the same.

To overcome this, the washing unit 30 may further include an ionizer 32 for emitting ions I toward the etching surface Tc of the target etch layer T, etc. and neutralizing the etching surface Tc of the target etch layer T, etc. charged by the washing particle C, and a suction unit 33 for adsorbing and removing the residual particles of the foreign substance R separated from the etching surface Tc of the target etch layer T, etc. by the washing particle C.

The ionizer 32 may be provided to emit the ions I such as cations/anions toward the etching surface Tc of the target etch layer T, etc. An installation location and driving time of the ionizer 32 are not particularly limited. For example, as shown in FIG. 14, the ionizer 32 may be installed in the washing section B in such a way that a discharge port 32a is directed toward the etching surface Tc of the target etch layer T, etc. of the processing target P passing through the washing section B and is spaced apart from the washing nozzle 31 by a predetermined distance. Thus, the ionizer 32 may emit the ions I toward the etching surface Tc of the target etch layer T, etc., which enter the washing section B from the etching section A. As such, the ionizer 32 may neutralize the etching surface Tc of the target etch layer T, etc. charged by the washing particle C.

The suction unit 33 may be provided to vacuum-adsorb and remove residual particles of the foreign substance R separated from the etching surface Tc of the target etch layer T, etc. using negative pressure applied from the outside through a suction line 33a. An installation location and driving time of the suction unit 33 are not particularly limited. For example, as shown in FIG. 14, the suction unit 33 may be installed in the washing section B in such a way that a suction port 33b is directed toward the etching surface Tc of the target etch layer T, etc. of the processing target P passing through the washing section B and is spaced apart from the washing nozzle 31 by a predetermined distance. Thus, the suction unit 33 may adsorb and remove residual particles of the foreign substance R separated from the etching surface Tc of the target etch layer T, etc. by the washing particle C in the washing section B.

As described above, the washing unit 30 may wash the etching surface Tc of the target etch layer T, etc. using dry ice fine particles and other washing particles C in a solid state. As such, when the etching surface Tc of the target etch layer T, etc. are washed using the washing particle C in a solid state, which is a sublimable material, damage of the etching surface Tc of the target etch layer T, etc. may be minimized and particles of carbon-based materials and various other types of foreign substances R included in the target etch layer T may be easily removed from the etching surface Tc of the target etch layer T, etc. compared with the case in which the etching surface Tc of the target etch layer T, etc. are washed through physical scraping using a washing member or chemical processing using a chemical material.

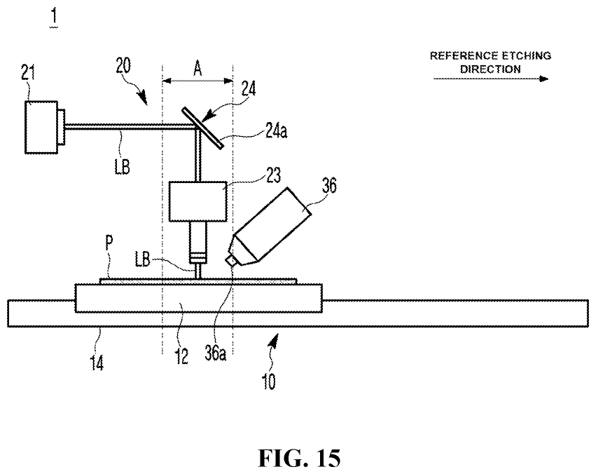

FIG. 15 is a side view showing a schematic configuration of a washing unit according to another embodiment.

As described above, the case in which the washing unit 30 includes the washing nozzle 31 having the plurality of discharge ports 31a has been described, but the present disclosure is not limited thereto. For example, as shown in FIG. 15, the washing unit 30 may include a washing nozzle 36 having one discharge port 36a instead or in addition to the washing nozzle 31. In this case, as shown in FIG. 15, the washing nozzle 36 may be installed in the etching section A to be spaced apart from the laser nozzle 23 by a predetermined interval to spray a washing material toward the etching surface Tc of the target etch layer T, etc. immediately after the etching surface Tc of the target etch layer T is etched. In this case, the ionizer 32 may be installed in the etching section A to be spaced apart from the laser nozzle 23 by a predetermined interval so as to emit the ions I toward the etching surface Tc of the target etch layer T, etc. immediately after the target etch layer T is etched, and the suction unit 33 may be installed in the etching section A to be spaced apart from the laser nozzle 23 by a predetermined interval so as to adsorb residual particles of the foreign substance R separated from the etching surface Tc of the target etch layer T, etc. by the washing particle C.

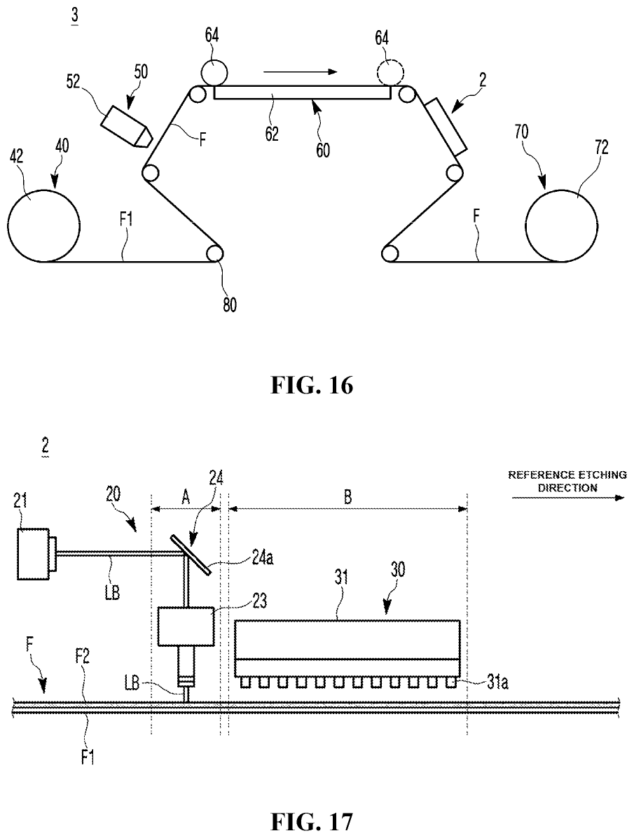

FIG. 16 is a side view showing a schematic configuration of an electrode manufacturing system including an etching apparatus installed therein according to another embodiment of the present disclosure. FIG. 17 is a side view showing a schematic configuration of the etching apparatus shown in FIG. 16.

An etching apparatus 2 according to another embodiment of the present disclosure may be different from the aforementioned etching apparatus 1 provided to etch and process the processing target P that is previously processed into a sheet shape in that the etching apparatus 2 is installed in an electrode manufacturing system 3 for manufacturing electrode fabric F having a strip shape in a roll-to-roll manner. For convenience of description, hereinafter, the electrode manufacturing system 3 will be described and then the etching apparatus 2 will be described.

First, the electrode manufacturing system 3 may include a supply unit 40 for supplying electrode current collector fabric F1, a coating unit 50 for forming the electrode fabric F by coating an electrode active material on one surface of the electrode current collector fabric F1 supplied by the supply unit 40, a rolling unit 60 for pressing an electrode active material layer F2 coated on the electrode current collector fabric F1 to adhere the electrode active material layer F2 to the electrode current collector fabric F1, a recovery unit 70 for recovering the electrode fabric F, and at least one guide roller 80 for guiding the electrode current collector fabric F1 or the electrode fabric F to supply the electrode current collector fabric F1 or the electrode fabric F along a predetermined supply path. Here, the electrode fabric F may refer to fabric including the electrode current collector fabric F1 and the electrode active material layer F2 formed by coating an electrode active material on one surface of the electrode current collector fabric F1.

The configuration of the supply unit 40 is not particularly limited. For example, the supply unit 40 may include a supply roll 42 for unwinding the electrode current collector fabric F1 that is previously wound and supplying the electrode current collector fabric F1 along the supply path.

The configuration of the coating unit 50 is not particularly limited. For example, the coating unit 50 may include a slot die coater 52 for forming the electrode fabric F by coating an electrode active material slurry on one surface of the electrode current collector fabric F1 that reaches a predetermined coating section of the supply path.

The configuration of the rolling unit 60 is not particularly limited. For example, the rolling unit 60 may include a heating plate 62 for heating the electrode active material coated on the electrode current collector fabric F1 that reaches a predetermined rolling section of the supply path, and a rolling roller 64 for pressing the electrode active material coated on the electrode current collector fabric F1 to adhere the electrode active material to the electrode current collector fabric F1 while traveling along the rolling section.

The configuration of the recovery unit 70 is not particularly limited. For example, the recovery unit 70 may include a recovery roll 72 for winding and recovering the electrode fabric F obtained by completely coating the electrode active material layer F2 and performing the rolling process.

Then, the etching apparatus 2 may be provided to etch and process the electrode active material layer F2 of the electrode fabric F. That is, in the case of the etching apparatus 2, the electrode fabric F may correspond to a processing target, the electrode current collector fabric F1 may correspond to a base material layer, and the electrode active material layer F2 may correspond to a target etch layer.

The etching apparatus 2 may be installed to etch and process the electrode fabric F obtained by completely coating the electrode active material and performing the rolling process. In this case, as shown in FIG. 16, the etching apparatus 2 may be installed between the rolling unit 60 and the recovery unit 70. However, the present disclosure is not limited thereto, and the etching apparatus 2 may also be installed to perform an etching process on the electrode fabric F obtained by only coating the electrode active material.

The configuration of the etching apparatus 2 is not particularly limited. For example, as shown in FIG. 17, the etching apparatus 2 may have the same configuration as the aforementioned etching apparatus 1 except that the etching apparatus 2 does not include the aforementioned supply unit 10. That is, the electrode current collector fabric F1 or the electrode fabric F may be supplied along a predetermined supply path by the supply roll 42 of the electrode manufacturing system 3, and thus, in consideration of this, the supply unit 10 that is included in the etching apparatus 2 itself may be omitted.

In this case, as shown in FIG. 17, the etching unit 20 may be installed to etch the electrode active material layer F2 of the electrode fabric F passing through a predetermined etching section A of the supply path. In response thereto, the washing unit 30 may be installed to wash the etch surface of the electrode active material layer F2 of the electrode fabric F passing through a predetermined washing section B of the supply path, an exposed surface of the electrode current collector fabric F1, exposed by etching the electrode active material layer F2, and so on.

As such, the etching apparatus 2 may be the same as the aforementioned etching apparatus 1 except that the shape and the supply method of a processing target are changed, and thus a detailed description of the etching apparatus 2 will be omitted.

The present disclosure relates to an etching apparatus and may have the following effects.

First, according to the present disclosure, a target etch layer may be shaped into a predetermined shape by etching a target etch layer of a processing target using a laser beam, and thus the quality of the processing target and a product manufactured using the same may be improved.

Second, according to the present disclosure, a laser beam may be shaped into an elliptical laser beam having a long axis parallel to a predetermined reference etching direction, and then the target etch layer may be etched by irradiating the target etch layer of the processing target with the elliptical laser beam shaped as such in the reference etching direction. As such, according to the present disclosure, an etch rate of the target etch layer may be improved, and the time and energy taken to etch the target etch layer may be reduced.

Third, according to the present disclosure, foreign substances may be removed by spraying a washing material to the foreign substance attached to an etch surface of the target etch layer, thereby preventing abnormalities from occurring in the quality of a processing target and a product manufactured using the same due to the foreign substance attached to the etch surface.

Fourth, according to the present disclosure, damage of the etching surface due to washing may be minimized through collision with washing particles in a solid state, which are a sublimable material, with foreign substances attached to the etch surface of the target etch layer, to remove the foreign substance compared with the case in which the foreign substances removed by scrape using a washing member or by processing the foreign substances with a chemical material, and particles of materials included in the target etch layer, oil, moisture, and various other foreign substances may be easily removed from the etch surface.

The above description is merely illustrative of the technical idea of the present disclosure, and it would be obvious to one of ordinary skill in the art that various modifications and variations can be made without departing from the essential features of the present disclosure.

Accordingly, the embodiments disclosed in the present disclosure are not intended to limit the technical idea of the present disclosure, but to explain the technical idea, and the scope of the technical idea of the present disclosure is not limited by these embodiments. The scope of protection for the present disclosure should be determined based on the following claims, and all technical ideas falling within the scope of equivalents thereto should be interpreted as being included in the scope of the present disclosure.

What is claimed is:

1. An etching apparatus comprising:
an etching unit including a laser oscillator configured to oscillate a laser beam for selectively etching a predetermined target etch layer included in a processing target having a multilayered structure, and a laser nozzle configured to selectively etch the target etch layer by irradiating the target etch layer with the laser beam; and
a washing unit including a washing nozzle configured to remove a foreign substance attached to an etch surface of the target etch layer by spraying a washing material to the etch surface of the target etch layer.

2. The etching apparatus according to claim 1, wherein the laser nozzle emits the laser beam along an etching scheduled line to form the etch surface along the etching scheduled line.

3. The etching apparatus according to claim 2, wherein the etching scheduled line is set to etch one end surface of the target etch layer along the etching scheduled line.

4. The etching apparatus according to claim 1, wherein the washing nozzle is configured in such a way that a washing particle in a solid state, which is a sublimable material, of the washing material collides with the etch surface.

5. The etching apparatus according to claim 4, wherein:
the washing material is carbon dioxide (CO2); and
the washing particle in a solid state is a dry ice fine particle.

6. The etching apparatus according to claim 4, wherein the washing nozzle is installed to be spaced apart from the etch surface by a predetermined distance to phase-transition a washing material in a liquid state sprayed toward the etch surface into the washing particle in a solid state during a procedure in which the washing material in a liquid state reaches the etch surface.

7. The etching apparatus according to claim 1, wherein:
the processing target further includes a base material layer stacked on one surface of the target etch layer; and
the laser oscillator generates and oscillates a laser beam for which a laser absorption rate of the target etch layer is higher than a laser absorption rate of the base material layer.

8. The etching apparatus according to claim 7, wherein, when the base material layer is formed of a metal material and the target etch layer is formed of a carbon-based material, the laser oscillator generates and oscillates an infrared laser beam.

9. The etching apparatus according to claim 1, wherein:
the etching unit further includes a beam shaping member configured to shape a circular laser beam oscillated from the laser oscillator into an elliptical laser beam; and
the laser nozzle irradiates the target etch layer with the elliptical laser beam along a long-axis direction of the elliptical laser beam.

10. The etching apparatus according to claim 9, further comprising:
a supply unit configured to supply the processing target in the long-axis direction along a predetermined supply path,
wherein the laser nozzle is installed to irradiate the target etch layer passing through a predetermined etching section on the supply path with the laser beam.

11. The etching apparatus according to claim 10, wherein the washing nozzle is installed to spray the washing material toward the etch surface of the processing target passing through a predetermined washing section positioned on a downstream side of the supply path compared with the etching section.

12. The etching apparatus according to claim 9, wherein the laser nozzle irradiates the target etch layer with the elliptical laser beam in such a way that beam spots of the elliptical laser beam overlap each other by a predetermined overlap ratio in the long-axis direction.

13. The etching apparatus according to claim 9, wherein the beam shaping member includes a plurality of cylindrical lenses installed at a predetermined interval on an optical path of the circular laser beam, and the cylindrical lenses are installed in such a way that a center line of a circumferential surface included in a corresponding cylindrical lens is parallel to the long-axis direction.

14. The etching apparatus according to claim 13, wherein the cylindrical lenses are installed to align a center axis of the corresponding cylindrical lens and an optical axis of the circular laser beam.

15. The etching apparatus according to claim 1, wherein the washing unit further includes a suction unit configured to absorb and remove the foreign substance separated from the etch surface by the washing particle.

16. The etching apparatus according to claim 15, wherein the washing unit further includes an ionizer configured to neutralize the etch surface by emitting ions toward the etch surface.
